(19) United States
(12) Patent Application Publication
(10) Pub. No.: US 2013/0293048 A1
(43) Pub. Date: Nov. 7, 2013

(54) HYDRODYNAMIC BEARING APPARATUS AND SPINDLE MOTOR HAVING THE SAME

(71) Applicant: SAMSUNG ELECTRO-MECHANICS CO., LTD., Suwon (KR)

(72) Inventors: Song Bon OH, Suwon (KR); Kum Kyung Lee, Suwon (KR)

(73) Assignee: Samsung Electro-Mechanics Co., Ltd., Suwon (KR)

(21) Appl. No.: 13/707,064

(22) Filed: Dec. 6, 2012

(30) Foreign Application Priority Data
May 2, 2012 (KR) 10-2012-0046563

(51) Int. Cl. F16C 32/06; H02K 7/08

(52) U.S. Cl. CPC F16C 32/06; H02K 7/085
USPC 310/90; 384/100

(57) ABSTRACT

There is provided a hydrodynamic bearing apparatus, including: a shaft; and a sleeve rotatably supporting the shaft; wherein at least one of an outer circumferential surface of the shaft and an inner circumferential surface of the sleeve is provided with upper and lower dynamic pressure grooves having a herringbone-shaped pattern provided therein so as to generate fluid dynamic pressure at the time of rotation of the shaft, and at least one of the upper and lower dynamic pressure grooves is formed such that a width of a pattern portion disposed in an upper portion thereof is different from that of a pattern portion disposed in a lower portion thereof, based on a center line.

### CROSS-REFERENCE TO RELATED APPLICATIONS

This application claims the priority of Korean Patent Application No. 10-2012-0046563 filed on May 2, 2012, in the Korean Intellectual Property Office, the disclosure of which is incorporated herein by reference.

### BACKGROUND OF THE INVENTION

1. Field of the Invention

The present invention relates to a hydrodynamic bearing apparatus and a spindle motor having the same.

2. Description of the Related Art

A small-sized spindle motor used in a hard disk drive (HDD) is generally provided with a hydrodynamic bearing apparatus, and a bearing clearance formed between a shaft and a sleeve included in the hydrodynamic bearing apparatus may be filled with a lubricating fluid such as oil. In addition, fluid dynamic pressure may be generated in the oil filling the bearing clearance while the oil is being pumped, thereby allowing for the shaft to be rotatably supported during the rotation thereof.

That is, hydrodynamic bearing apparatuses are generally provided with a thrust dynamic pressure groove having a spiral shaped pattern provided therein or a journal dynamic pressure groove having a herringbone-shaped pattern provided therein to generate fluid dynamic pressure so as to improve stability in a rotation of a motor.

In addition, a pair of journal dynamic pressure grooves may be formed in a sleeve so as to generate fluid dynamic pressure in a radial manner.

Recently, with an increase in capacity of hard disk drives, a technical problem in which vibrations generated during the driving of a spindle motor should be reduced has arisen. That is, in order for hard disk drives to be driven without errors occurring therein, due to vibrations generated during the driving of the spindle motor, improvements in the performance of the hydrodynamic bearing apparatus included in the spindle motor have been demanded.

To this end, there is a need to reduce vibrations generated during the driving of the motor by enlarging an interval (that is, increasing a bearing span length) between the journal dynamic pressure grooves having the herringbone-shaped pattern provided therein.

However, in order to prevent a lubricating fluid from being scattered to the outside of the hydrodynamic bearing apparatus and to prevent negative pressure from being generated in the inside of the hydrodynamic bearing apparatus, pattern portions provided in upper and lower portions of the journal dynamic pressure groove are formed to be asymmetrical, based on a region of maximum pressure (centered on a center line between the journal dynamic pressure grooves having the herringbone-shaped pattern provided therein).

As a result, in order for the lubricating fluid to move downwardly from the sleeve, the pattern portions provided in the upper portion of the journal dynamic pressure groove and the pattern portions provided in the lower portion thereof are asymmetrically formed with regard to each other, based on a region in which maximum pressure is generated.

This may cause a reduction in a bearing span length.

Therefore, there is a need to develop a hydrodynamic bearing apparatus structure capable of increasing the bearing span length while reducing the occurrence of negative pressure and suppressing the scattering of the lubricating fluid.

### RELATED ART DOCUMENT

(Patent Document 1) Japanese Patent Laid-Open Publication No. 2001-140858

### SUMMARY OF THE INVENTION

An aspect of the present invention provides a hydrodynamic bearing apparatus having improved rotational characteristics and a spindle motor having the same.

According to an aspect of the present invention, there is provided a hydrodynamic bearing apparatus, including: a shaft; and a sleeve rotatably supporting the shaft; wherein at least one of an outer circumferential surface of the shaft and an inner circumferential surface of the sleeve is provided with upper and lower dynamic pressure grooves having a herringbone-shaped pattern provided therein so as to generate fluid dynamic pressure at the time of rotation of the shaft, and at least one of the upper and lower dynamic pressure grooves is formed such that a width of a pattern portion disposed in an upper portion thereof is different from that of a pattern portion disposed in a lower portion thereof, based on a center line.

The upper dynamic pressure groove may be formed such that the width of the pattern portion disposed in the upper portion thereof is smaller than that of the pattern portion disposed in the lower portion thereof, based on the center line.

The lower dynamic pressure groove may be formed such that the width of the pattern portion disposed in the upper portion thereof is larger than that of the pattern portion disposed in the lower portion thereof, based on the center line.

The at least one of the upper and lower dynamic pressure grooves may be formed such that an axial length of the pattern portion disposed in the upper portion thereof is equal to that of the pattern portion disposed in the lower portion thereof, based on the center line.

An axial length of the upper dynamic pressure groove may be equal to that of the lower dynamic pressure groove.

An axial length of the upper dynamic pressure groove may be larger than that of the lower dynamic pressure groove.

The upper and lower dynamic pressure grooves may have an oil storage groove disposed therebetween.

According to another aspect of the present invention, there is provided a spindle motor, including: a shaft; a sleeve rotatably supporting the shaft; a base member to which the sleeve is fixed; and a rotor hub fixed to an upper end of the shaft and rotating together with the shaft, wherein at least one of an outer circumferential surface of the shaft and an inner circumferential surface of the sleeve is provided with upper and lower dynamic pressure grooves having a herringbone-shaped pattern provided therein so as to generate fluid dynamic pressure at the time of rotation of the shaft, and at least one of the upper and lower dynamic pressure grooves is formed such that a width of a pattern portion disposed in an upper portion thereof is different from that of a pattern portion disposed in a lower portion thereof, based on a center line.

The upper dynamic pressure groove may be formed such that the width of the pattern portion disposed in the upper portion thereof is smaller than that of the pattern portion disposed in the lower portion thereof, based on the center line, and the lower dynamic pressure groove may be formed such that the width of the pattern portion disposed in the upper portion thereof is larger than that of the pattern portion disposed in the lower portion thereof, based on the center line.

The at least one of the upper and lower dynamic pressure grooves may be formed such that an axial length of the pattern portion disposed in the upper portion thereof is equal to that of the pattern portion disposed in the lower portion thereof, based on the center line.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor including a hydrodynamic bearing apparatus according to an embodiment of the present invention;

FIG. 2 is a view illustrating a sleeve included in the hydrodynamic bearing apparatus according to the embodiment of the present invention;

FIG. 3 is a cross-sectional view taken along line A-A′ of FIG. 2;

FIG. 4 is a graph illustrating an effect of the hydrodynamic bearing apparatus according to the embodiment of the present invention;

FIG. 5 is a view illustrating a sleeve included in a hydrodynamic bearing apparatus according to another embodiment of the present invention; and

FIG. 6 is a graph illustrating an effect of the hydrodynamic bearing apparatus according to another embodiment of the present invention.

### DETAILED DESCRIPTION OF THE EMBODIMENTS

Hereinafter, exemplary embodiments of the present invention will be described with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, when it is determined that the detailed description of the known art related to the present invention may obscure the gist of the present invention, a detailed description thereof will be omitted.

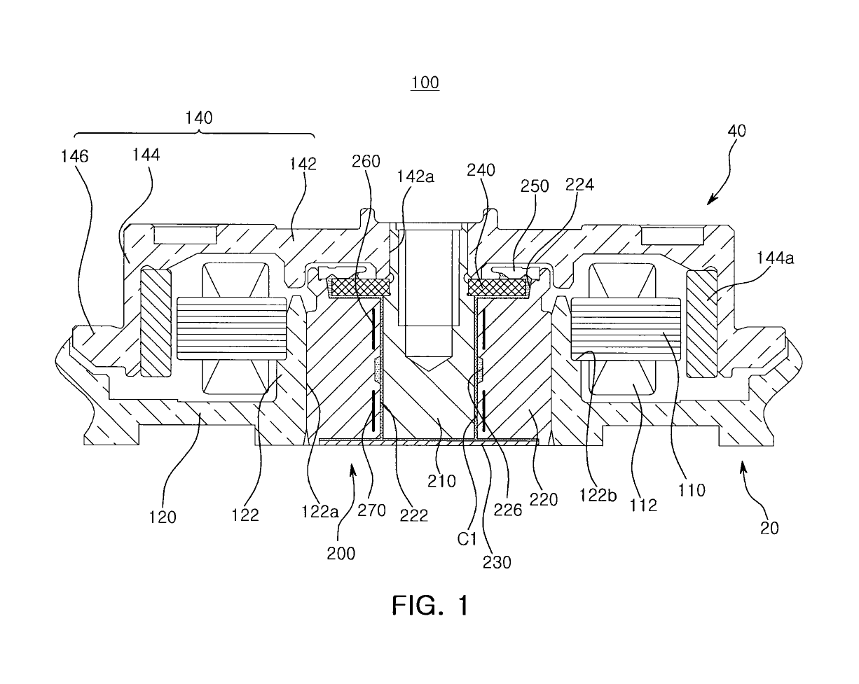

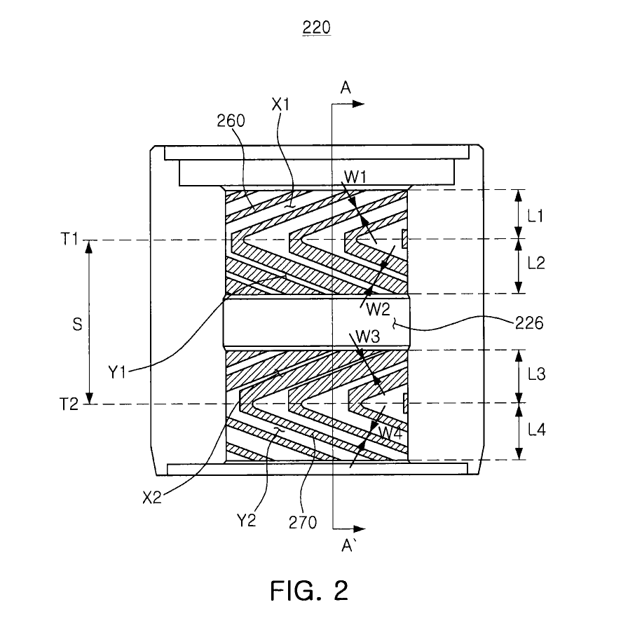

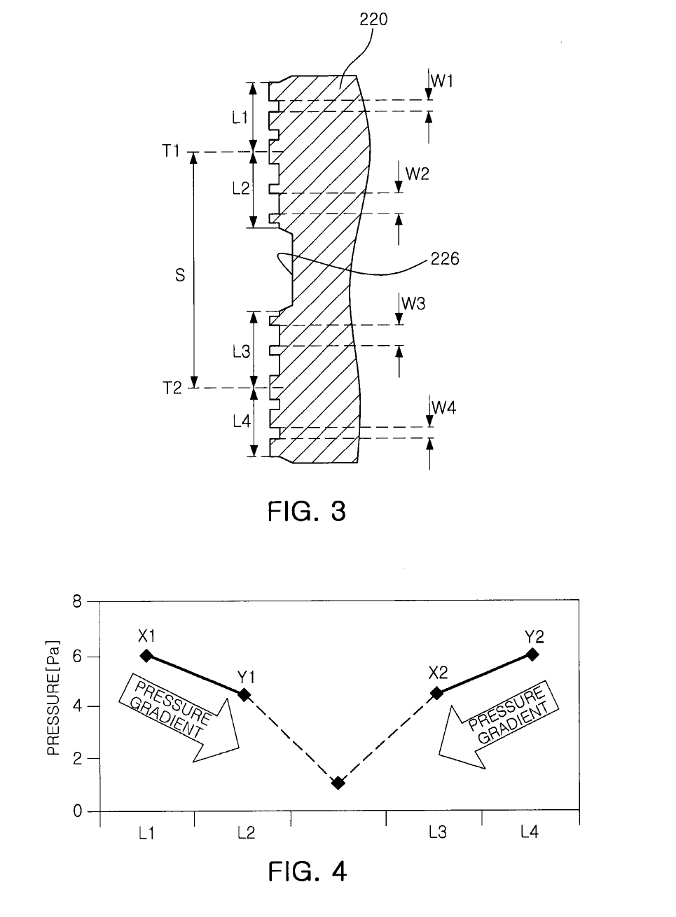

FIG. 1 is a schematic cross-sectional view showing a spindle motor including a hydrodynamic bearing apparatus according to an embodiment of the present invention, FIG. 2 is a view illustrating a sleeve included in the hydrodynamic bearing apparatus according to the embodiment of the present invention, and FIG. 3 is a cross-sectional view taken along line A-A′ of FIG. 2.

Referring to FIGS. 1 through 3, a spindle motor 100 according to an embodiment of the present invention may include a base member 120, a hydrodynamic bearing apparatus 200, and a rotor hub 140.

Further, the hydrodynamic bearing apparatus 200 according to the embodiment of the present invention may include a shaft 210, a sleeve 220, a cover member 230, a thrust plate 240, and a cap member 250.

Meanwhile, the spindle motor 100 may be a motor used in a hard disk drive driving a recoding disk.

Here, terms with respect to directions will be defined. As shown in FIG. 1, an axial direction refers to a vertical direction, that is, a direction from a lower portion of the shaft 210 toward an upper portion thereof or a direction from the upper portion of the shaft 210 toward the lower portion thereof, while a radial direction refers to a horizontal direction, that is, a direction from an outer circumferential surface of the rotor hub 140 toward the shaft 210 or from the shaft 210 toward the outer circumferential surface of the rotor hub 140.

In addition, a circumferential direction refers to a rotational direction along an outer circumferential surface of the rotor hub 140 and the shaft 210.

The spindle motor 100 according to the embodiment of the present invention may mainly be configured of a stator 20 and a rotor 40. The stator 20 includes all fixed members rotatably supporting the rotor 40, and the rotor 40 includes rotating members supported by the stator 20 to thereby rotate.

The base member 120, a fixed member rotatably supporting the rotor 40, may configure the stator 20. In addition, the base member 120 may include a mounting part 122 to which the sleeve 220 is fixed.

The mounting part 122 may be protruded upwardly in the axial direction and include a mounting hole 122a to allow the sleeve 220 to be inserted thereinto. That is, the sleeve 220 may be fixed to the mounting part 122.

Meanwhile, the mounting part 122 may include a step part 122b provided on an outer circumferential surface thereof so that a stator core 110 may be inserted thereinto. That is, the stator core 110 may be fixed to the mounting part 122 in a state in which it is seated on the step part 122b formed on the outer circumferential surface of the mounting part 122.

The hydrodynamic bearing apparatus 200 pumps lubricating fluid at the time of the rotation of the shaft 210 to generate fluid dynamic pressure. Details relating to the hydrodynamic bearing apparatus 200 will be described below.

The rotor hub 140 is fitted to the shaft 210 and rotates. That is, the rotor hub 140, a rotating member that rotates together with the shaft 210, configures the rotor 40 and is fixed to the upper portion of the shaft 210.

In addition, the rotor hub 140 may include a disk shaped body 142 having an mounting hole 142a formed therein, the mounting hole 142a having the shaft 210 inserted thereinto, a magnet mounting part 144 extended downwardly from an edge of the body 142 in the axial direction, and a disk seating part 146 extended outwardly from a distal end of the magnet mounting part 144 in the radial direction.

That is, the rotor hub 140 may have a cup shape and form an internal space together with the base member 120. In addition, the stator core 110 may be disposed in the internal space formed by the rotor hub 140 and the base member 120.

In addition, the magnet mounting part 144 may be fixedly provided with a driving magnet 144a. That is, the driving magnet 144a may be fixed to the inner circumferential surface of the magnet mounting part 144 so as to be disposed to face an edge of the stator core 110.

In addition, the driving magnet 144a may have an annular ring shape and may be a permanent magnet generating magnetic force having a predetermined strength by alternately magnetizing an N pole and an S pole in the circumferential direction. That is, the driving magnet 144a may serve to generate driving force for rotating the rotor hub 140.

In other words, when power is supplied to a coil 112 wound around the stator core 110, force capable of rotating the rotor hub 140 may be generated by electromagnetic interaction between the stator core 110 having the coil 110 wound therearound and the driving magnet 144a. Therefore, the rotor hub 140 may rotate.

As a result, the shaft 210 and the thrust plate 240 fixed to the shaft 210 may also rotate together with the rotor hub 140 by the rotation of the rotor hub 140.

As described above, when the rotor hub 140 rotates, the lubricating fluid filling the hydrodynamic bearing apparatus 200 is pumped to generate fluid dynamic pressure.

Hereinafter, the hydrodynamic bearing apparatus 200 will be described in more detail.

The shaft 210 may be a rotating member configuring the rotor 40 rotatably supported by the stator 20. That is, the shaft 210 may be rotatably supported by the sleeve 220.

In addition, the sleeve 220 may be a fixed member configuring the stator 20 together with the base member 120 and rotatably supporting the rotor 40.

In addition, the sleeve 220 may be fixed to the mounting part 122 as described above. In addition, the sleeve 220 may have a through-hole 222 formed in the center thereof, and the shaft 210 may be inserted into the through-hole 222 to be rotatably supported by the sleeve 220.

Meanwhile, when the shaft 210 is inserted into the through hole 222, the outer circumferential surface of the shaft 210 and the inner circumferential surface of the sleeve 220 are spaced apart from each other by a predetermined clearance to form a bearing clearance C1.

In addition, this bearing clearance C1 may be filled with the lubricating fluid so as to generate fluid dynamic pressure at the time of the rotation of the shaft 210.

Further, upper and lower dynamic pressure grooves 260 and 270 for generating fluid dynamic pressure at the time of the rotation of the shaft 210 may be formed in at least one of the outer circumferential surface of the shaft 210 and the inner circumferential surface of the sleeve 220.

In addition, the upper and lower dynamic pressure grooves 260 and 270 may have a herringbone-shaped pattern provided therein.

In addition, at least one of the upper and lower dynamic pressure grooves 260 and 270 may be formed such that a width of a pattern portion provided in an upper portion thereof is different from that of the pattern portion provided in a lower portion thereof, based on the center line.

Herein, when defining terms such as “axial direction” and “width,” used in illustrating the upper and lower dynamic pressure grooves 260 and 270, the axial direction of the upper and lower dynamic pressure grooves 260 and 270 refers to a vertical direction in FIG. 2, namely, an L direction (that is, a length direction) and the width refers to W1 to W4 shown in FIG. 2.

First, the upper dynamic pressure groove 260 will be described.

The upper dynamic pressure groove 260 may have the herringbone-shaped pattern provided therein angled at a center line T1. Further, the upper dynamic pressure groove 260 may be formed such that an axial length L1 of the pattern portion provided in the upper portion thereof is equal to an axial length L2 of the pattern portion provided in the lower portion thereof.

Further, the upper dynamic pressure groove 260 may be formed such that a width W1 of the pattern portion provided in the upper portion thereof is smaller than a width W2 of the pattern portion provided in the lower portion thereof, based on the center line.

Therefore, based on the center line T1 at the time of the rotation of the shaft 210, pressure generated by the pattern portion provided in the upper portion of the upper dynamic pressure groove 260 may be higher than that generated by the pattern portion provided in the lower portion thereof.

That is, as shown in FIG. 4, at the time of the rotation of the shaft 210, the pressure at a pattern portion X1 disposed in the upper portion of the upper dynamic pressure groove 260 may be higher than that at a pattern portion Y1 disposed in the lower portion thereof.

As a result, the lubricating fluid filling the bearing clearance C1 may be pumped downwardly from the upper portion of the upper dynamic pressure groove 260 to the lower portion thereof due to the pressure differential.

Therefore, the generation of negative pressure between the upper and lower dynamic pressure grooves 260 and 270 may be suppressed. Here, the negative pressure refers to pressure lower than atmospheric pressure.

In addition, the width W1 of the pattern portion disposed in the upper portion of the upper dynamic pressure groove 260 is formed to be smaller than the width W2 of the pattern portion provided in the lower portion thereof and therefore, the axial length L1 of the pattern portion disposed in the upper portion of the upper dynamic pressure groove 260 may be equal to the axial length L2 of the pattern portion disposed in the lower portion thereof based on the center line T1.

Therefore, a span length S may be increased. A detailed description thereof will be provided below.

Here, the span length S indicates an axial distance between a point at which maximum dynamic pressure is generated when the lubricating fluid is pumped by the upper dynamic pressure groove 260 and a point at which maximum dynamic pressure is generated when the lubricating fluid is pumped by the lower dynamic pressure groove 270.

Next, the lower dynamic pressure groove 270 will be described.

The lower dynamic pressure groove 270 may have the herringbone-shaped pattern provided therein angled at a center line T2. Further, the lower dynamic pressure groove 270 may be formed such that an axial length L3 of the pattern portion provided in the upper portion thereof is equal to an axial length L4 of the pattern portion provided in the lower portion thereof.

Further, the lower dynamic pressure groove 270 may be formed such that a width W3 of the pattern portion provided in the upper portion thereof is larger than a width W4 of the pattern portion provided in the lower portion thereof, based on the center line.

Therefore, based on the center line T2 at the time of the rotation of the shaft 210, pressure generated by the pattern portion disposed in the upper portion of the lower dynamic pressure groove 270 may be lower than that generated by the pattern portion disposed in the lower portion thereof.

That is, as shown in FIG. 4, at the time of the rotation of the shaft 210, the pressure at a pattern portion X2 disposed in the upper portion of the lower dynamic pressure groove 270 may be lower than that at a pattern portion Y2 disposed in the lower portion thereof.

As a result, the lubricating fluid filling the bearing clearance C1 may be pumped downwardly from the upper portion of the lower dynamic pressure groove 270 to the lower portion thereof due to the pressure differential.

Therefore, the generation of negative pressure between the upper and lower dynamic pressure grooves 260 and 270 may be suppressed.

In addition, the width W3 of the pattern portion disposed in the upper portion of the upper dynamic pressure groove 270 is formed to be larger than the width W4 of the pattern portion provided in the lower portion thereof and therefore, the axial length L3 of the pattern portion disposed in the upper portion of the lower dynamic pressure groove 270 may be equal to the axial length L4 of the pattern portion provided in the lower portion thereof, based on the center line T2.

Therefore, the span length S may be increased.

That is, in the related art, the axial length of the pattern portion disposed in the upper portion of the upper dynamic pressure groove is formed to be larger than that of the pattern portion disposed in the lower portion thereof. Further, the axial length of the pattern portion disposed in the lower portion of the lower dynamic pressure groove is formed to be larger than that of the pattern portion disposed in the upper portion thereof.

However, the widths W1 and W3 of the pattern portions disposed in the upper portions of the upper and lower dynamic pressure grooves 260 and 270 are different from the widths W2 and W4 of the pattern portions disposed in the lower portions thereof, based on the center lines T1 and T2, and therefore, the axial lengths L1 and L3 of the pattern portions disposed in the upper portions thereof may be equal to the axial lengths L2 and L4 of the pattern portions disposed in the lower portions thereof.

As a result, the length between the center lines T1 and T2 is increased and therefore, the span length S may be increased.

Meanwhile, the sleeve 220 may be provided with an oil storage groove 226, disposed between the upper and lower dynamic pressure grooves 260 and 270.

The cover member 230 is mounted under the sleeve 220 and serves to prevent the lubricating fluid from being leaked downwardly from the sleeve 220.

Further, when the cover member 230 is mounted in the sleeve 220, the lubricating fluid also fills a space formed by the cover member 230 and the sleeve 220. In addition, when the shaft 210 is mounted in the sleeve 220, a lower surface of the shaft 210 may contact an upper surface of the cover member 230.

Further, when the shaft 210 rotates, the lubricating fluid is injected into the space formed by the sleeve 220 and the cover member 230, such that the shaft 210 may be floated to a predetermined height.

The thrust plate 240 may be fixed to the shaft 210 so as to be disposed under the rotor hub 140. Therefore, the thrust plate 240 may rotate together with the shaft 210. That is, the thrust plate 240 is a rotating member configuring the rotor 40 together with the shaft 210.

In addition, when the shaft 210 is mounted in the sleeve 220, the thrust plate 240 may be inserted into an insertion groove 224 of the sleeve 220.

In addition, a thrust dynamic pressure groove (not shown) may be formed in at least one of a lower surface of the thrust plate 240 and a lower surface of the insertion groove 224 in order to generate thrust fluid dynamic pressure at the time of the rotation of the thrust plate 240.

The cap member 250 may be fixed to the sleeve 220 so as to be disposed above the thrust plate 240. In other words, the cap member 250 may be a fixed member configuring the stator 20 together with the sleeve 220.

In addition, an interface between the lubricating fluid and air may be formed by a lower surface of the cap member 250 and an upper surface of the thrust plate 240. To this end, a lower end of the cap member 250 may be provided with an inclined surface.

That is, an interface between the lubricating fluid filling the bearing clearance and air may be formed in the space formed by the lower surface of the cap member 250 and the upper surface of the thrust plate 240 by a capillary phenomenon.

As described above, the upper and lower dynamic pressure grooves 260 and 270 are formed such that the axial lengths L1 and L3 of the pattern portions disposed in the upper portions thereof are equal to the axial lengths L2 and L4 of the pattern portions disposed in the lower portions of the dynamic pressure grooves 260 and 270, based on the center lines T1 and T2, and therefore, the span length S of the hydrodynamic bearing apparatus 200 according to the embodiment of the present invention may be increased.

As a result, the rotational characteristics of the shaft 210 may be improved due to the increase in the span length S.

In addition, the width W1 of the pattern portion disposed in the upper portion of the upper dynamic pressure groove 260 is formed to be smaller than the width W2 of the pattern portion provided in the lower portion thereof and the width W3 of the pattern portion disposed in the upper portion of the lower dynamic pressure groove 270 is formed to be larger than the width W4 of the pattern portion provided in the lower portion thereof, and therefore, the generation of negative pressure may be suppressed in the oil storage groove 226, disposed between the upper and lower dynamic pressure grooves 260 and 270.

Hereinafter, a hydrodynamic bearing apparatus according to another embodiment of the present invention will be described with reference to the drawings. However, a description of components the same as those described above will be omitted.

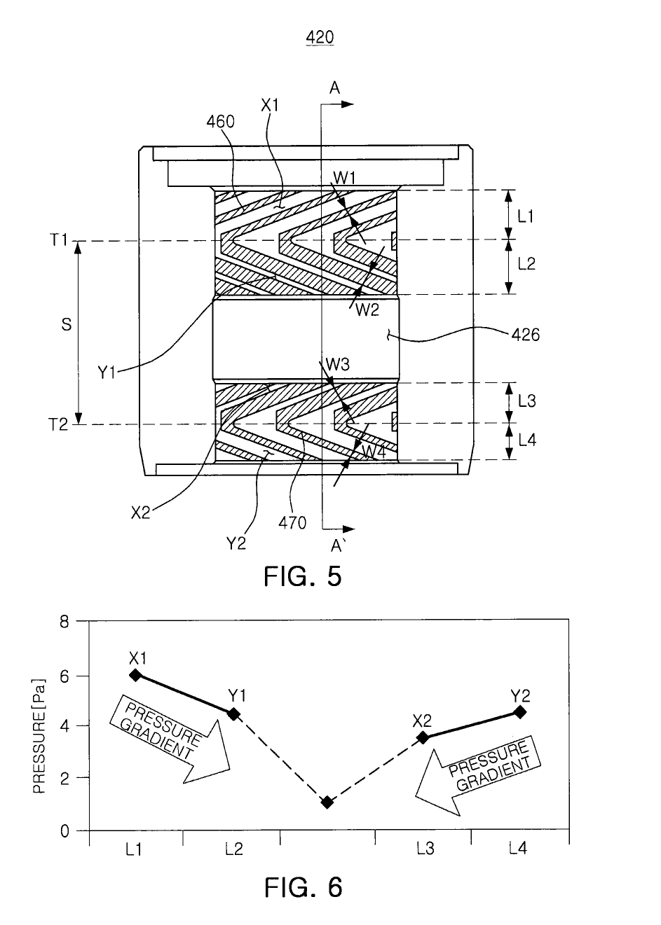

FIG. 5 is a view illustrating a sleeve included in a hydrodynamic bearing apparatus according to another embodiment of the present invention, and FIG. 6 is a graph illustrating an effect of the hydrodynamic bearing apparatus according to another embodiment of the present invention.

Referring to FIGS. 5 and 6, a hydrodynamic bearing apparatus (not shown) according to another embodiment of the present invention may include a shaft (not shown) and a sleeve 420. Further, the hydrodynamic bearing apparatus according to this embodiment of the present invention has the same structure as that of the hydrodynamic bearing apparatus 200 according to the above-described embodiment of the present invention, except for the sleeve 420, and therefore, a detailed description thereof will be omitted.

That is, only the sleeve 420 will be described in detail below.

Upper and lower dynamic pressure grooves 460 and 470 may be formed in an inner circumferential surface of the sleeve 420 so as to generate fluid dynamic pressure at the time of the rotation of the shaft.

In addition, the upper and lower dynamic pressure grooves 460 and 470 may have a herringbone-shaped pattern provided therein.

In addition, at least one of the upper and lower dynamic pressure grooves 460 and 470 may be formed so that a width of a pattern portion disposed in an upper portion thereof is different from that of a pattern portion disposed in a lower portion thereof, based on a center line.

First, the upper dynamic pressure groove 460 will be described.

The upper dynamic pressure groove 460 may have the herringbone-shaped pattern provided therein angled at a center line T1. Further, the upper dynamic pressure groove 460 may be formed such that an axial length L1 of the pattern portion provided in the upper portion thereof is equal to an axial length L2 of the pattern portion provided in the lower portion thereof.

Further, the upper dynamic pressure groove 460 may be formed such that a width W1 of the pattern portion provided in the upper portion thereof is smaller than a width W2 of the pattern portion provided in the lower portion thereof, based on the center line.

Therefore, pressure generated by the pattern portion disposed in the upper portion may be higher than that generated by the pattern portion disposed in the lower portion, based on the center line T1 at the time of the rotation of the shaft 210 (see FIG. 1).

That is, as shown in FIG. 6, at the time of the rotation of the shaft 210, the pressure at a pattern portion X1 disposed in the upper portion of the upper dynamic pressure groove 460 may be higher than that at a pattern portion Y1 disposed in the lower portion thereof.

As a result, the lubricating fluid filling the bearing clearance C1 may be pumped downwardly from the upper portion of the upper dynamic pressure groove 460 to the lower portion thereof due to the pressure differential.

Therefore, the generation of negative pressure between the upper and lower dynamic pressure grooves 460 and 470 may be suppressed. Here, negative pressure refers to pressure lower than atmospheric pressure.

In addition, the width W1 of the pattern portion disposed in the upper portion of the upper dynamic pressure groove 460 is formed to be smaller than the width W2 of the pattern portion disposed in the lower portion thereof, and therefore, the axial length L1 of the pattern portion disposed in the upper portion of the upper dynamic pressure groove 460 may be equal to the axial length L2 of the pattern portion disposed in the lower portion thereof, based on the center line T1.

Therefore, a span length S may be increased. A detailed description thereof will be provided below.

Here, the span length S indicates an axial distance between a point at which maximum dynamic pressure is generated when the lubricating fluid is pumped by the upper dynamic pressure groove 460 and a point at which maximum dynamic pressure is generated when the lubricating fluid is pumped by the lower dynamic pressure groove 470.

Next, the lower dynamic pressure groove 470 will be described.

The lower dynamic pressure groove 470 may have the herringbone-shaped pattern provided therein angled at a center line T2. Further, the lower dynamic pressure groove 470 may be formed such that an axial length L3 of the pattern portion provided in the upper portion thereof is equal to an axial length L4 of the pattern portion provided in the lower portion thereof.

Further, the lower dynamic pressure groove 470 may be formed such that a width W3 of the pattern portion provided in the upper portion thereof is larger than a width W4 of the pattern portion provided in the lower portion thereof, based on the center line.

Therefore, based on the center line T2 at the time of the rotation of the shaft 210, pressure generated by the pattern portion disposed in the upper portion of the lower dynamic pressure groove 470 may be lower than that generated by the pattern portion disposed in the lower portion thereof.

That is, as shown in FIG. 6, at the time of the rotation of the shaft 210, the pressure at a pattern portion X2 disposed in the upper portion of the lower dynamic pressure groove 470 may be lower than that at a pattern portion Y2 disposed in the lower portion thereof.

As a result, the lubricating fluid filling the bearing clearance C1 may be pumped downwardly from the upper portion of the lower dynamic pressure groove 470 to the lower portion thereof due to the pressure differential.

Therefore, the generation of negative pressure between the upper and lower dynamic pressure grooves 460 and 470 may be suppressed.

In addition, the width W3 of the pattern portion disposed in the upper portion of the lower dynamic pressure groove 470 is formed to be larger than the width W4 of the pattern portion disposed in the lower portion thereof, and therefore, the axial length L3 of the pattern portion disposed in the upper portion of the lower dynamic pressure groove 470 may be equal to the axial length L4 of the pattern portion disposed in the lower portion thereof, based on the center line T2.

Therefore, the span length S may be increased.

That is, in the related art, the axial length of the pattern portion disposed in the upper portion of the upper dynamic pressure groove is formed to be larger than that of the pattern portion disposed in the lower portion thereof. Further, the axial length of the pattern portion disposed in the lower portion of the lower dynamic pressure groove is formed to be larger than that of the pattern portion provided in the upper portion thereof.

However, the widths W1 and W3 of the pattern portions disposed in the upper portions of the upper and lower dynamic pressure grooves 460 and 470 are different from the widths W2 and W4 of the pattern portions disposed in the lower portions thereof based on the center lines T1 and T2, and therefore, the axial lengths L1 and L3 of the pattern portions disposed in the upper portions thereof may be equal to the axial lengths L2 and L4 of the pattern portions disposed in the lower portions thereof.

As a result, the length between the center lines T1 and T2 is increased, and therefore, the span length S may be increased.

Meanwhile, the sleeve 420 may be provided with an oil storage groove 426, disposed between the upper and lower dynamic pressure grooves 460 and 470.

Meanwhile, the axial length L1+L2 of the upper dynamic pressure groove 460 may be formed to be larger than the axial length L3+L4 of the lower dynamic pressure groove 470. That is, when the hydrodynamic bearing apparatus according to this embodiment of the present invention is used for an ultra-thin type spindle motor, the axial length L1+L2 of the upper dynamic pressure groove 460 is formed to be larger than the axial length L3+L4 of the lower dynamic pressure groove 470, thereby securing the span length S.

Therefore, the rotational characteristics may be improved even in the ultra-thin type spindle motor.

As set forth above, according to embodiments of the present invention, the widths of the pattern portions disposed in the upper portions of the upper and lower dynamic pressure grooves are different from those of the pattern portions disposed in the lower portions thereof based on the center line, and therefore, the axial lengths of the pattern portions disposed in the upper and lower portions thereof are formed to be equal to each other, thereby increasing the span length.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing apparatus, comprising:
a shaft; and
a sleeve rotatably supporting the shaft;
wherein at least one of an outer circumferential surface of the shaft and an inner circumferential surface of the sleeve is provided with upper and lower dynamic pressure grooves having a herringbone-shaped pattern provided therein so as to generate fluid dynamic pressure at the time of rotation of the shaft, and
at least one of the upper and lower dynamic pressure grooves is formed such that a width of a pattern portion disposed in an upper portion thereof is different from that of a pattern portion disposed in a lower portion thereof, based on a center line.

2. The hydrodynamic bearing apparatus of claim 1, wherein the upper dynamic pressure groove is formed such that the width of the pattern portion disposed in the upper portion thereof is smaller than that of the pattern portion disposed in the lower portion thereof, based on the center line.

3. The hydrodynamic bearing apparatus of claim 1, wherein the lower dynamic pressure groove is formed such that the width of the pattern portion disposed in the upper portion thereof is larger than that of the pattern portion disposed in the lower portion thereof, based on the center line.

4. The hydrodynamic bearing apparatus of claim 1, wherein the at least one of the upper and lower dynamic pressure grooves is formed such that an axial length of the pattern portion disposed in the upper portion thereof is equal to that of the pattern portion disposed in the lower portion thereof, based on the center line.

5. The hydrodynamic bearing apparatus of claim 1, wherein an axial length of the upper dynamic pressure groove is equal to that of the lower dynamic pressure groove.

6. The hydrodynamic bearing apparatus of claim 1, wherein an axial length of the upper dynamic pressure groove is larger than that of the lower dynamic pressure groove.

7. The hydrodynamic bearing apparatus of claim 1, wherein the upper and lower dynamic pressure grooves have an oil storage groove disposed therebetween.

8. A spindle motor, comprising:
a shaft;
a sleeve rotatably supporting the shaft;
a base member to which the sleeve is fixed; and
a rotor hub fixed to an upper end of the shaft and rotating together with the shaft,
wherein at least one of an outer circumferential surface of the shaft and an inner circumferential surface of the sleeve is provided with upper and lower dynamic pressure grooves having a herringbone-shaped pattern provided therein so as to generate fluid dynamic pressure at the time of rotation of the shaft, and
at least one of the upper and lower dynamic pressure grooves is formed such that a width of a pattern portion disposed in an upper portion thereof is different from that of a pattern portion disposed in a lower portion thereof, based on a center line.

9. The spindle motor of claim 8, wherein the upper dynamic pressure groove is formed such that the width of the pattern portion disposed in the upper portion thereof is smaller than that of the pattern portion disposed in the lower portion thereof, based on the center line, and
the lower dynamic pressure groove is formed such that the width of the pattern portion disposed in the upper portion thereof is larger than that of the pattern portion disposed in the lower portion thereof, based on the center line.

10. The spindle motor of claim 8, wherein the at least one of the upper and lower dynamic pressure grooves is formed such that an axial length of the pattern portion disposed in the upper portion thereof is equal to that of the pattern portion disposed in the lower portion thereof, based on the center line.
